(19) United States
(12) Patent Application Publication
(10) Pub. No.: US 2012/0155261 A1
(43) Pub. Date: Jun. 21, 2012

(54) DATA PROCESSING METHOD AND DEVICE

(75) Inventors: Hun Soon LEE, Daejeon (KR); Mi Young LEE, Daejeon (KR)

(73) Assignee: Electronics and Telecommunications Research Institute, Daejeon (KR)

(21) Appl. No.: 13/323,419

(22) Filed: Dec. 12, 2011

(30) Foreign Application Priority Data
Dec. 16, 2010 (KR) 10-2010-0129527

(51) Int. Cl. H04L 12/26

(52) U.S. Cl. 370/230.1; 370/252

(57) ABSTRACT

Disclosed is a data processing method and device according to the present invention, including: calculating a maximum allowable delay time of each of a plurality of operators that constitute a plurality of services and are executed according to a data processing request of a user; classifying the plurality of operators based on the calculated maximum allowable delay time; calculating a quality of service (QoS) satisfaction allowable level with respect to each of the plurality of operators, wherein the allowable level for QoS satisfaction indicates the number of times that there is no need to satisfy one goal of QoS with the premise that there is no problem in satisfying QoS satisfaction requested by the user; setting execution orders of the plurality of classified operators by reflecting the calculated allowable level for QoS satisfaction; and executing the plurality of operators based on the set execution orders.

### CROSS-REFERENCE TO RELATED APPLICATIONS

This application claims priority to and the benefit of Korean Patent Application No. 10-2010-0129527 filed in the Korean Intellectual Property Office on Dec. 16, 2010, the entire contents of which are incorporated herein by reference.

### TECHNICAL FIELD

The present invention relates to a data processing method and device, and more particularly, to a data processing method and device that may improve the user satisfaction with respect to a service provided to the user by increasing quality of service (QoS).

### BACKGROUND

A data flow continuous processing system is a system that efficiently provides a data analysis and processing service in near real time by dynamically dispersing and distributing and thereby continuously processing online stream data processing operations in a large stream data explosion environment that aperiodically occurs online/offline. When a user registers, to a system, information about input data and a plurality of operators to be executed on corresponding data, the system continuously processes new data using a plurality of nodes and transfers a result every time the new data is generated and is input.

In the meantime, when the user requests a service execution, that is, data processing, information about how to process data that is endlessly continuously generated using a means provided from the system, for example, a query language and the like and thereby flow, and to use the processed data for an application service is transferred together with a goal of quality of service (QoS).

At the time when the term QoS was created in the network field, the QoS has indicated a set of service requirements that are to be satisfied in a network for data transmission of a suitable level. However, while the term QoS is gradually becoming popularized, the QoS is used as a meaning indicating a capability of providing a priority to another application program or service, another user, or another data flow, or guaranteeing a predetermined level of throughput.

The goal of QoS desired for each application service may vary even in the data flow continuous processing field. For example, in the case of a medical related bio data application service, accuracy is most important. In the case of a Web data analysis application service of processing large data in real time, a processing time is more important than the accuracy and thus, an approximate value may be allowed to some extents. Also, the QoS is associated with a user as well as an application service. That is, increasing the QoS means that user satisfaction will be increased.

In the data flow continuous processing field, the following technologies have been studied in association with the goal of QoS.

A system such as STREAM developed by Stanford University of the U.S.A. processes a data processing request of a user by setting, as the goal of QoS, minimizing of execution memory load in order to enhance performance of the system.

A system such as AURORA jointly developed by Brown University, the MIT, and Brandy University sets, as the goal of QoS, minimizing a response time or a delay time for each service or application program, and minimizing the number of tuples compulsory load shedding, as a method of improving the user satisfaction with respect to a service, and processes the data processing request of the user in order to maximally satisfy the goal of QoS through scheduling under presumption that operators between services are not shared.

A method of receiving a deadline for each service and setting a satisfaction with respect thereto as the goal of QoS and thereby considering that there are sharing of operators and constraints on orders of operators is proposed as another method. The proposed method performs processing to maximally satisfy the goal of QoS with respect to multiple queries.

FIG. 1 is a flowchart showing a data processing method according to a conventional art in a case where a goal of QoS is to satisfy an accuracy level and a maximum delay time, that is, a deadline.

It is assumed that a service request or a data processing request of a user is executed using a plurality of operators as described above, and that an actual used processing time with respect to each of operators that constitute the data processing request of the user, that is, a data flow continuous processing request is monitored while processing data, and is processed as an estimated processing time required with respect to an operator and thereby is managed. Also, it is assumed that the data processing requests are processed to satisfy the minimum accuracy level.

Referring to FIG. 1, initially, to process input data within a maximum delay time based on data input time and an estimated processing time required with respect to each of operators, a deadline by which each of the operators needs to complete processing of input data is calculated (210). The operators are classified into operators having a high deadline satisfaction probability and operators having a low deadline satisfaction probability according to a deadline satisfaction probability that is based on the calculated deadline (220). Execution orders of the operators are determined according to a scheduling policy using operator classification information according to the deadline and the deadline satisfaction probability (230). Here, the execution orders are determined so that the operators having the high deadline satisfaction probability may be initially executed in scheduling. That is, the operators having the low deadline satisfaction probability are selected as victim operators not satisfying QoS. The operators are executed one by one based on the scheduling result (240).

As described above, conventional arts have made efforts to maximally satisfy QoS at all times. When it is impossible to satisfy a QoS criterion, the conventional arts select as victim operators incapable of satisfying the QoS criterion through a system, not a user selection, and thereby process the operators. It becomes a main reason of decreasing the user satisfaction.

### SUMMARY

The present invention has been made in an effort to provide a data processing method and device that can satisfy a goal of quality of service (QoS) individualized for each application service.

The present invention has been made in an effort to a data processing method and device that can increase the satisfaction of a user using a service.

An exemplary embodiment of the present invention provides a data processing method including: calculating a maximum allowable delay time of each of a plurality of operators that constitute a plurality of services and are executed according to a data processing request of a user, classifying the plurality of operators based on the calculated maximum allowable delay time, calculating an allowable level for QoS satisfaction with respect to each of the plurality of operators, wherein the allowable level for QoS satisfaction indicates the number of times that there is no need to satisfy one goal of QoS with the premise that there is no problem in satisfying QoS satisfaction requested by the user, setting execution orders of the plurality of classified operators by reflecting the calculated allowable level for QoS satisfaction, and executing the plurality of operators based on the set execution orders.

An execution order of an operator having a margin in the calculated allowable level for QoS satisfaction is set to be later. When sacrificial QoS criterion information of an operator having a margin in the calculated allowable level for QoS satisfaction is accuracy, an execution order of the operator is set to be later after shedding load of the operator. When sacrificial QoS criterion information of an operator having a margin in the calculated allowable level for QoS satisfaction is a delay time, an execution order of the operator is set to be later.

The setting of the execution orders of the plurality of classified operators by reflecting the calculated allowable level for QoS satisfaction may include verifying sacrificial QoS criterion information of an operator having a margin in the calculated allowable level for QoS satisfaction, when the sacrificial QoS criterion information of an operator having a margin in the calculated allowable level for QoS satisfaction is accuracy, setting an execution order of the operator to be later after shedding load of the operator, and when the sacrificial QoS criterion information of an operator having a margin in the calculated allowable level for QoS satisfaction is a delay time, setting an execution order of the operator to be later.

The QoS satisfaction expectation information and/or the sacrificial QoS criterion information is set by the user.

Another exemplary embodiment of the present invention provides a data processing device including a communication module to be connected to or communicate with a plurality of operators that constitute a plurality of services and are executed according to a data processing request of a user, and a scheduler to calculate a maximum allowable delay time of each of the plurality of operators, to classify the plurality of operators based on the calculated maximum allowable delay time, to calculate an allowable level for QoS satisfaction with respect to each of the plurality of operators, to set execution orders of the plurality of classified operators by reflecting the calculated allowable level for QoS satisfaction, and to execute the plurality of operators based on the set execution orders, wherein the allowable level for QoS satisfaction indicates the number of times that there is no need to satisfy one goal of QoS with the premise that there is no problem in satisfying QoS satisfaction requested by the user.

An execution order of an operator having a margin in the calculated allowable level for QoS satisfaction is set to be later. When sacrificial QoS criterion information of an operator having a margin in the calculated allowable level for QoS satisfaction is accuracy, an execution order of the operator is set to be later after shedding load of the operator. When sacrificial QoS criterion information of an operator having a margin in the calculated allowable level for QoS satisfaction is a delay time, an execution order of the operator is set to be later.

The scheduler may be to verify sacrificial QoS criterion information of an operator having a margin in the calculated allowable level for QoS satisfaction, thereby when the sacrificial QoS criterion information of an operator having a margin in the calculated allowable level for QoS satisfaction is accuracy, setting an execution order of the operator to be later after shedding load of the operator, and when the sacrificial QoS criterion information of an operator having a margin in the calculated allowable level for QoS satisfaction is a delay time, setting an execution order of the operator to be later.

The sacrificial QoS criterion information may be set by the user.

Yet another exemplary embodiment of the present invention provides a data processing method including: requesting, by a user, data processing that is executed by a plurality of operators constituting a plurality of services; and receiving an execution result according to a data processing request of the user, wherein the data processing may be performed by calculating a maximum allowable delay time of each of the plurality of operators, classifying the plurality of operators based on the calculated maximum allowable delay time, calculating an allowable level for QoS satisfaction with respect to each of the plurality of operators, wherein the allowable level for QoS satisfaction indicates the number of times that there is no need to satisfy one goal of QoS with the premise that there is no problem in satisfying QoS satisfaction requested by the user, setting execution orders of the plurality of classified operators by reflecting the calculated allowable level for QoS satisfaction, and executing the plurality of operators based on the set execution orders.

An execution order of an operator having a margin in the calculated allowable level for QoS satisfaction is set to be later. When sacrificial QoS criterion information of an operator having a margin in the calculated allowable level for QoS satisfaction is accuracy, an execution order of the operator is set to be later after shedding load of the operator. When sacrificial QoS criterion information of an operator having a margin in the calculated allowable level for QoS satisfaction is a delay time, an execution order of the operator is set to be later.

The setting of the execution orders of the plurality of classified operators by reflecting the calculated allowable level for QoS satisfaction may include verifying sacrificial QoS criterion information of an operator having a margin in the calculated allowable level for QoS satisfaction, when the sacrificial QoS criterion information of an operator having a margin in the calculated allowable level for QoS satisfaction is accuracy, setting an execution order of the operator to be later after shedding load of the operator, and when the sacrificial QoS criterion information of an operator having a margin in the calculated allowable level for QoS satisfaction is a delay time, setting an execution order of the operator to be later.

The sacrificial QoS criterion information may be set by the user.

According to exemplary embodiments of the present invention, there is provided a data processing method and device that may satisfy a goal of QoS individualized for each application service.

According to exemplary embodiments of the present invention, there is provided a data processing method and device that may increase the satisfaction of a user using a service.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a flowchart illustrating a data processing method according to a conventional art in a case where a goal of quality of service (QoS) satisfies an accuracy level and a maximum delay time, that is, a deadline.

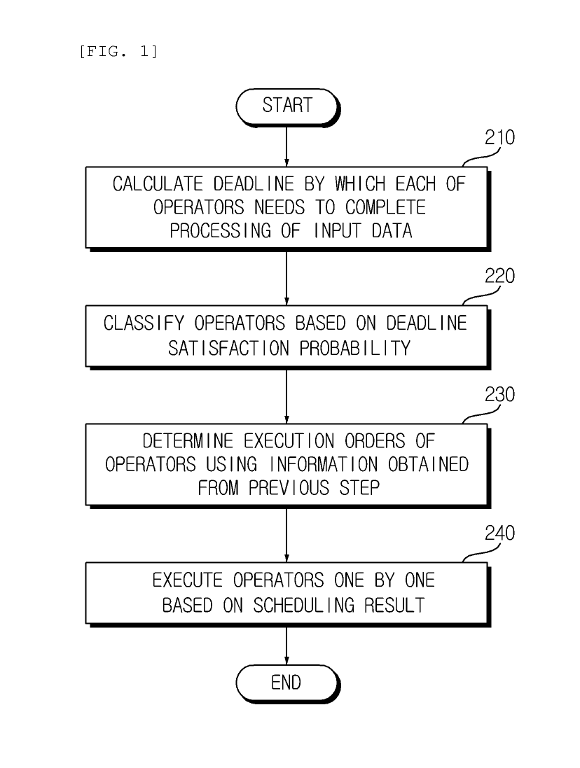

FIG. 2 is a schematic diagram illustrating a structure of a data flow continuous processing system according to an exemplary embodiment of the present invention.

FIG. 3 is a flowchart illustrating a data processing method according to an exemplary embodiment of the present invention in a case where a goal of QoS is to satisfy an accuracy level and a maximum delay time, that is, a deadline.

FIG. 4 is a flowchart illustrating a data processing method according to another exemplary embodiment of the present invention.

FIG. 5 is a table showing various types of information values about each of operators used in a data processing method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The following exemplary embodiments are combined with constituent components and features of the present invention in a predetermined form. Each of the constituent components or features may be selectively considered unless it is explicitly mentioned. Each of the constituent components or features may be implemented without combination with other constituent components or features. Also, a portion of the constituent components or features may be combined with each other, thereby constituting the exemplary embodiments of the present invention. Orders of operations described in the exemplary embodiments of the present invention may be changed. A portion of configurations or features of an exemplary embodiment may be included in another exemplary embodiment, or may be replaced with a configuration or a feature corresponding to the other exemplary embodiment.

The embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

Predetermined terms used in the following description are provided to help the understanding of the present invention and uses of the predetermined terms may be modified without departing from the scope of the technical fields of the present invention.

Hereinafter, exemplary embodiments of the present invention will be described in detail with reference to the accompanying drawings.

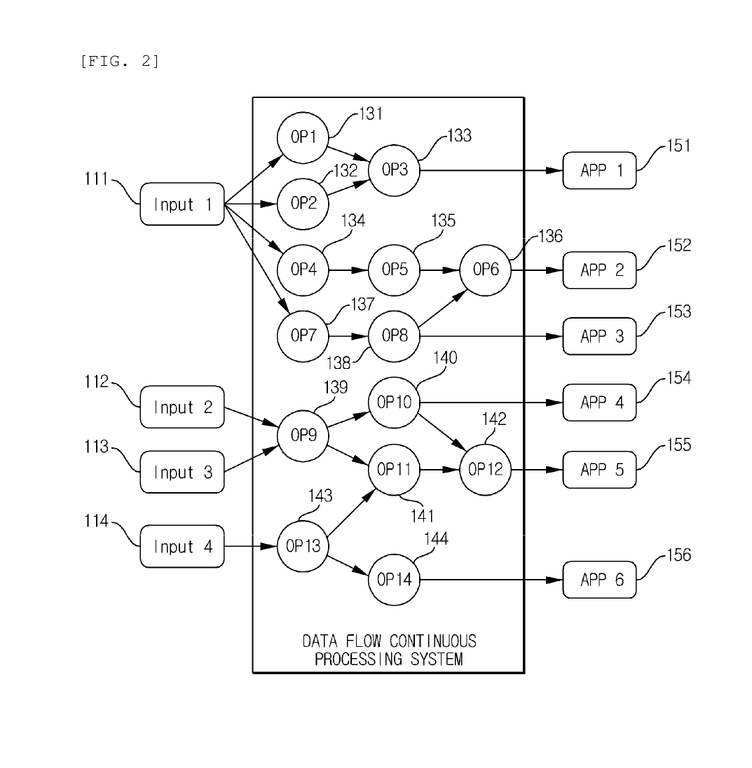

FIG. 2 is a schematic diagram illustrating a structure of a data flow continuous processing system according to an exemplary embodiment of the present invention.

Referring to FIG. 2, the data flow continuous processing system receives data from a plurality of external inputs (Input1 to Input4, 111 to 114) and continuously processes the data using a plurality of operators (OP1 to OP14, 131 to 144) included within the data flow continuous processing system, and then transfers the processing result to application services (APP1 to APP6, 151 to 156), i.e., external outputs.

In general, a data processing request of a user may be expressed as a network of operators, for example, the operators 131 to 134, where a processing result of one operator is used as input of another operator(s). For example, as shown in FIG. 2, the operator (OP1) 131 receives data from the input (Input1) 111 and processes the data and then transfers the processing result to the operator (OP3) 133. The operator (OP3) 133 receives the processing result of the operator (OP1) 131 as an input and processes the processing result and then, transfers the processing result to the application service (APP1) 151.

The application services 151 to 156 denote various types of services using big data such as a Web data analysis application, a new biotechnology application, a financial data analysis application, and the like, as well as a service that needs to analyze and process large stream data in (near) real time, such as a real-time personalization service, a recommendation service, a closed-circuit television (CCTV) based security service, and the like, in various application environments including an Internet service.

Operators constituting a so-called application service that is a data processing request may receive data from one input and process the data (for example, operators 131, 132, 134, 135, 137, 138, 140, 143, and 144), and may receive data from at least two inputs and process the data (for example, operators 133, 136, 139, 141, and 142). Also, the operators may transfer a processing result to one operator or application service (for example, operators 131, 132, 133, 134, 135, 136, 137, 141, 142, and 144), and may transfer the processing result to at least two operators or application services (for example, operators 138, 139, 140, and 143). In addition, an operator may be shared to generate a result to be transferred to at least two application services (for example, operators 138, 139, 140, and 143).

A data processing method and device according to an exemplary embodiment of the present invention is associated with scheduling operators that execute data processing when processing data according to a data processing request of a user based on the data flow continuous processing system and transferring the processing result to the user, in particular, so that the user may receive the processing result suitable for a desired goal of QoS. Here, a scheduler that is an apparatus to perform the scheduling may exist as a portion of the data flow continuous processing system and may also be configured as a separate apparatus. The data flow continuous processing system or the scheduler may include a communication module (not shown) to connect to or communicate with the plurality of operators.

In the meantime, a user does not always desire a QoS criterion requested by the user to be satisfied when requesting service processing. Also, a level for satisfying the QoS criterion may be different for each application service. For example, the user may desire the QoS criterion to be satisfied at all times with respect to some application services and may also desire only 95% or more of the QoS criterion to be satisfied with respect to other application services. Also, in a case where all of a plurality of QoS criteria cannot be satisfied, the user may desire that a predetermined QoS criterion is to be satisfied even though a portion of the plurality of QoS criteria is eased. For example, there may be a user that desires a delay time to be satisfied even though accuracy about the result of service is partially sacrificed.

Accordingly, goal of QoS satisfaction individualized for each service, proposed in the present invention, may be achieved by transferring the information about the goal of QoS for each service together with a data processing request. Here, the information about the goal of QoS for a data flow continuous processing service, proposed in the present invention, may include accuracy of result corresponding to a QoS criterion and an allowable service delay widely used in general, and may further include QoS satisfaction expectation information and/or sacrificial goal of QoS information.

The accuracy of result corresponds to information about to which level of accuracy is required for the result, and may be expressed as, for example, percentage (%). This information may be used for compulsory load shedding of a system. The data flow continuous processing system according to an exemplary embodiment of the present invention may perform compulsory load shedding from the start using the above information, and may also perform compulsory load shedding only in an overload circumstance. Here, compulsory load shedding may be a scheme of deleting at least a portion of data to be processed when input data explosion occurs and the like.

An allowable service delay indicates a standby time, for example, a maximum delay time that can be used until a data processing result of a requested service is transferred and thereby the service is provided. When the allowable service delay is used together with data input time whereby a corresponding time elapses, it is determined that a corresponding service does not satisfy QoS.

QoS satisfaction expectation information indicates-QoS satisfaction expected by the user and may be expressed by a real number between 0.0 and 1.0. For example, when QoS satisfaction expectation information is 0.99, it may indicate that a goal of QoS is to be satisfied 99 times out of 100 times.

In other words, in the present invention, the QoS satisfaction indicates a ratio of the number of times that the service is performed with satisfying the goal of QoS with respect to the total number of times that the service is performed, and is expressed as a real number between 0.0 and 1.0. 0.0 indicates that the goal of QoS is not satisfied even once, and 1.0 indicates that the goal of QoS is satisfied every time the service is performed. To calculate the QoS satisfaction, the number of times that is a reference to measure the QoS satisfaction is received from the user. For example, if the criterion is 10,000 times, it is to guarantee the QoS satisfaction with respect to the latest 10,000 times of service performances. In an initial stage, it is considered that previous 10,000 times of services performances has all satisfied the goal of QoS. In a data flow continuous processing method according to an exemplary embodiment of the present invention, in a state where the user initially registers information about input data and a service as a network of a plurality of operators to process the input data, processing is continuously performed with new data being input. Accordingly, to prevent measured QoS satisfaction from being distorted, the number of times that is a measurement reference needs to be sufficiently large. In particular, in an initial service registration stage, the measurement needs to be performed after a sufficient warming-up time.

Finally, sacrificial goal of QoS information indicates information about a goal of QoS to be sacrificed and/or a sacrificial level thereof when another QoS among a plurality of goal of QoSs cannot be satisfied while performing data processing. Here, the user may select one QoS criterion from among the plurality of QoS criteria, for example, accuracy of result and an allowable service delay, or may entrust the selection to the system.

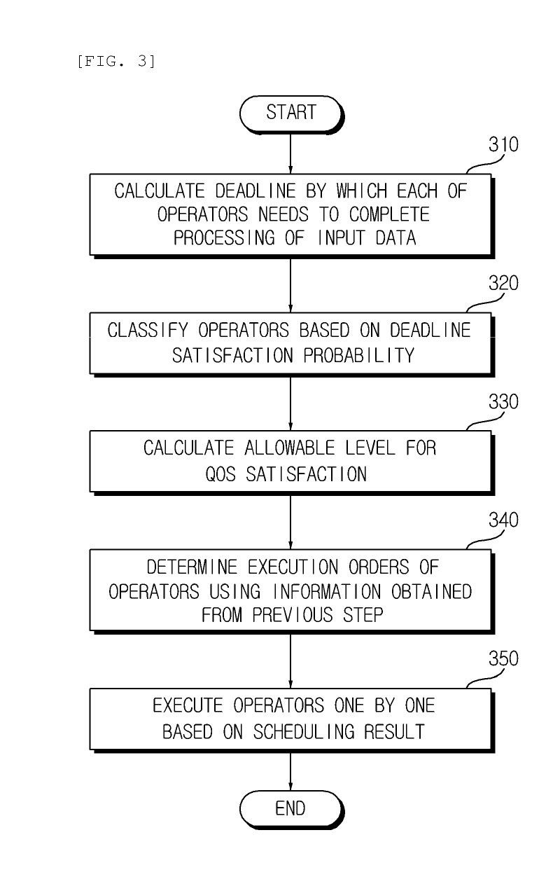

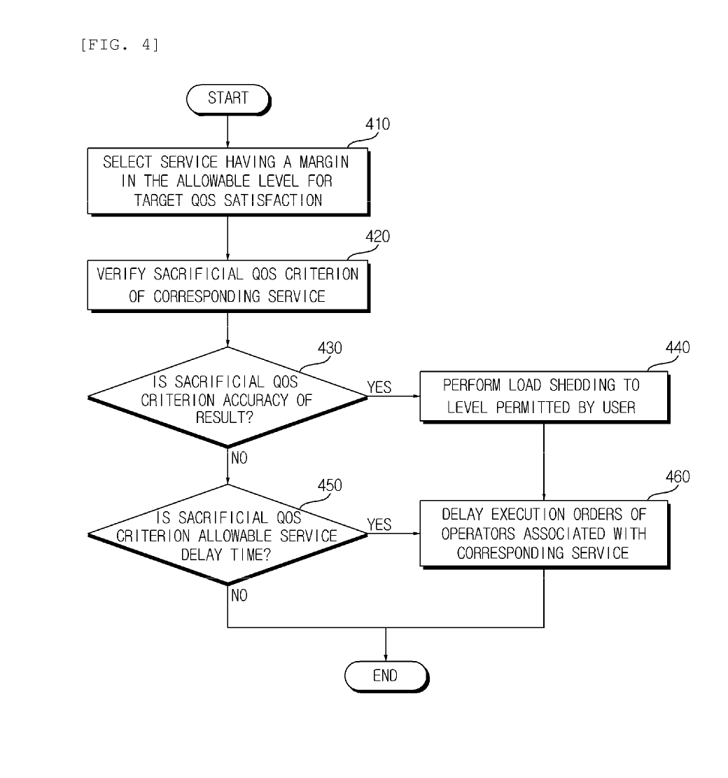

A data processing method according to an exemplary embodiment of the present invention including scheduling of operators in which a selection or an intent of a user is reflected using the QoS satisfaction expectation information and/or sacrificial goal of QoS information will be described with reference to FIGS. 3 and 4.

The goal of QoS used in the present invention is not limited to the above-noted accuracy of result, allowable service delay, QoS satisfaction expectation information, and sacrificial goal of QoS information and indicates further including QoS satisfaction expectation information and/or sacrificial goal of QoS information in addition to a general goal of QoS such as accuracy of result and allowable service delay. Therefore, the present invention describes that an operator scheduling process performs scheduling by basically including accuracy and a maximum delay time, however, is not limited thereto and may also be applied to a case where any other QoS criterion is added or deducted.

FIG. 3 is a flowchart illustrating a data processing method according to an exemplary embodiment of the present invention in a case where a goal of QoS satisfies an accuracy level and a maximum delay time, that is, a deadline.

A service request or a data processing request of a user is configured as a network of a plurality of operators as shown in FIG. 2, and it is assumed that actual used processing time with respect to each of the operators constituting a data flow continuous processing request is monitored and is processed as an estimated processing time required with respect to each operator and thereby is managed. Also, it is assumed that the data processing requests are being processed to satisfy the minimum accuracy level.

Referring to FIG. 3, initially, to process input data within a maximum delay time based on a data input time and an estimated processing time required with respect to each of operators, a deadline by which each of the operators needs to complete processing of input data is calculated (310). The operators are classified into operators having a high deadline satisfaction probability and operators having a low deadline satisfaction probability based on a deadline satisfaction probability that is based on the calculated deadline (320).

Allowable level for QoS satisfaction is calculated (330). Here, the allowable level for QoS satisfaction indicates the number of times that there is no need to satisfy one goal of QoS with the premise that there is no problem in satisfying QoS satisfaction requested by the user. A detailed definition about the allowable level for QoS satisfaction and an embodiment of a calculation method thereof will be described later.

Execution orders of the operators are determined according to a scheduling policy using operator classification information according to the deadline and the deadline satisfaction probability and allowable level information about the QoS satisfaction and the operators are inserted into an execution operator standby queue (340). The operators are selected one by one based on the scheduling result, that is, from the execution operator standby queue that is the scheduling result, and thereby are executed (350).

The allowable level for QoS satisfaction according to the present invention indicates the number of times that there is no problem in satisfying the QoS satisfaction requested by the user even though the accuracy of result and/or the deadline that is the goal of QoS in a future performance is not satisfied, and may be calculated according to the following Equation 1:

R=A−U [Equation 1]

R: allowable level for QoS satisfaction

A: Allowable number of QoS dissatisfactions

U: Number of QoS dissatisfactions among the reference number of measurements previously performed

The allowable number of QoS dissatisfactions A corresponds to the allowable number of QoS dissatisfactions within the range where QoS satisfaction expectation information requested by a user is satisfied when a service is performed as many as the number of times corresponding to a measurement reference of QoS satisfaction, and may be calculated according to the following Equation 2:

A=(1−S)×N [Equation 2]

A: Allowable number of QoS dissatisfactions

S: QoS satisfaction expectation information requested by a user

N: Reference number of measurements

For example, when the user requested 0.99 of QoS satisfaction and the number of times corresponding to the measurement reference is 1000 times and the goal of QoS was dissatisfied three times out of the latest 1000 times, the allowable level for QoS satisfaction is calculated as follows. First, the allowable number of QoS dissatisfactions becomes 10 according to (1−0.99)×1000. Since the number of QoS dissatisfactions is 3 among the reference number of measurements previously performed and thus, the allowable level for QoS satisfaction becomes 10-3, that is, 7 times.

As described above, as shown in FIG. 3, according to the present invention, when it is impossible to satisfy QoS with respect to all the operators in scheduling, it is possible to improve the overall user satisfaction by selecting and sacrificing a service having an allowable level for QoS satisfaction.

FIG. 4 is a flowchart illustrating a data processing method according to another exemplary embodiment of the present invention. In particular, to improve the user satisfaction, FIG. 4 may be added to FIG. 3 whereby scheduling may be performed.

Referring to FIG. 4, a service having an allowable level for QoS satisfaction is selected (410). A sacrificial QoS criterion of the selected service, i.e., sacrificial goal of QoS information thereof is verified (420). In this instance, when one same sacrificial goal of QoS is used for all the services, the above step may be omitted.

When the verified sacrificial QoS criterion is accuracy of result (430), load shedding is performed to a level permitted by the user (440) and then, scheduling orders of operators associated with the corresponding service are set to be delayed (460). In this instance, a load shedding ratio as information about load shedding may be pre-stored for the whole services or each service through a system or a user input. This is to ultimately increase a QoS with respect to another data and/or whole data processing request by decreasing an amount of a resource required for data processing of operators associated with the corresponding service, that is, a memory, a central processing unit (CPU), and the like, and thereby enabling the corresponding resource to be further used for other operator processing. Also, by setting an execution order of a service having a relatively high allowable level for QoS satisfaction to be later, it is possible to give a priority opportunity to the other service having a relatively low allowable level for QoS satisfaction so that the other service may satisfy QoS.

In the meantime, when the verified sacrificial QoS criterion is an allowable service delay time (450), execution orders of operators associated with the corresponding service are delayed (460).

As described above, the data processing method of FIG. 4 is an embodiment of a method for improving the user satisfaction according to the present invention. The process shown in FIG. 4 may be repeatedly applied so that more services may satisfy the goal of QoS in scheduling to which the data processing method according to the present invention is actually applied. That is, to improve the user satisfaction at the whole system level, at least one service having the allowable level for QoS satisfaction may be selected and be sacrificed.

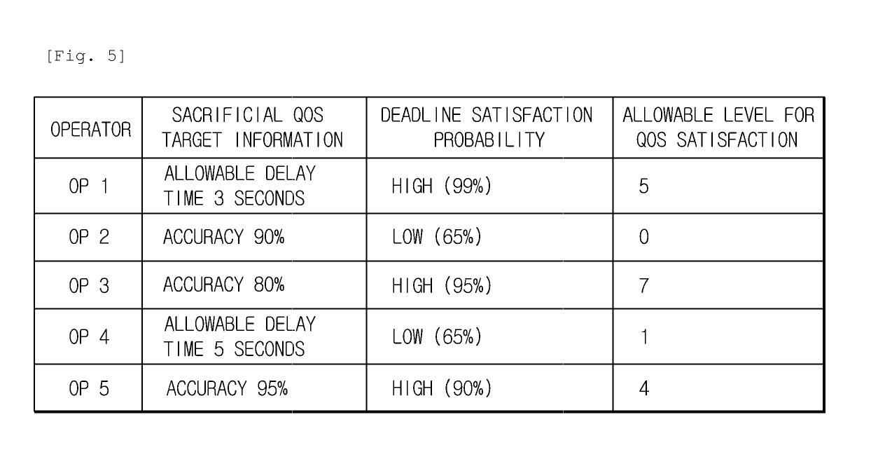

FIG. 5 is a table showing various types of information values about each of operators used in a data processing method according to an exemplary embodiment of the present invention.

Referring to FIG. 5, scheduling proceeds as follows with respect to five operators OP1, OP2, OP3, OP4, and OP5 that are scheduling targets. For convenience, it is assumed that each of the operators constitutes a different service. When one operator is shared by at least one service, or when one service is configured using at least one operator, execution orders there between may be determined according to an additional scheduling policy.

In the conventional method, scheduling is performed so that operators having a high deadline satisfaction probability may be initially executed and then, scheduling is performed with respect to operators having a low deadline satisfaction probability. Accordingly, for example, the operators may be scheduled and thereby executed in an order of OP1, OP3, OP5, OP2, and OP4. In this instance, execution orders between OP2 and OP4 may be determined according to a predetermined scheduling policy. Accordingly, OP2 and OP4 are set to have later execution orders and thus, it becomes further difficult to satisfy the deadline that is the QoS criterion.

Unlike the conventional method, the method proposed in the present invention may select OP3 having a relatively high allowable level for QoS satisfaction and thereby set an execution order of OP3 to be later. Accordingly, the operators may be scheduled and thereby be executed in an order of OP1, OP5, OP2, OP4, and OP3. Thus, a goal of QoS of OP3 is to decrease accuracy to 80% and delay an execution order, that is, set an execution order to be later and thereby enable OP2 and OP4 to be initially executed prior to OP3, thereby increasing a probability capable of satisfying a corresponding QoS. From view of the whole service provided from the system, it is possible to improve the user satisfaction.

A data processing method and apparatus of the present invention may be applied to any of technology fields associated with various types of services using large capacity data such as a Web data analysis, a new biotechnology data application, a financial data analysis application, and the like, as well as a service that needs to analyze and process large capacity stream data in (near) real time, such as a real-time personalization service, a recommendation service, a CCTV based security service, and the like, in various application environments including an Internet service.

A data processing method and apparatus of the present invention may be readily applied to a system requiring QoS such as a distributed data processing system, a job processing system, and the like, as well as a data flow continuous processing system, thereby overall improving the user satisfaction with respect to a service provided from a corresponding system.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A data processing method comprising:
calculating a maximum allowable delay time of each of a plurality of operators that constitute a plurality of services and are executed according to a data processing request of a user;
classifying the plurality of operators based on the calculated maximum allowable delay time;
calculating a quality of service (QoS) satisfaction allowable level with respect to each of the plurality of operators, wherein the allowable level for QoS satisfaction indicates the number of times that there is no need to satisfy one goal of QoS with the premise that there is no problem in satisfying QoS satisfaction requested by the user;
setting execution orders of the plurality of classified operators by reflecting the calculated allowable level for QoS satisfaction; and
executing the plurality of operators based on the set execution orders.

2. The method of claim 1, wherein an execution order of an operator having a margin in the calculated allowable level for QoS satisfaction is set to be later.

3. The method of claim 1, wherein when sacrificial QoS criterion information of an operator having a margin in the calculated allowable level for QoS satisfaction is accuracy, an execution order of the operator is set to be later after shedding load of the operator.

4. The method of claim 1, wherein when sacrificial QoS criterion information of an operator having a margin in the calculated allowable level for QoS satisfaction is a delay time, an execution order of the operator is set to be later.

5. The method of claim 1, wherein the setting of the execution orders of the plurality of classified operators by reflecting the calculated allowable level for QoS satisfaction comprises:
verifying sacrificial QoS criterion information of an operator having a margin in the calculated allowable level for QoS satisfaction;
when the sacrificial QoS criterion information of an operator having a margin in the calculated allowable level for QoS satisfaction is accuracy, setting an execution order of the operator to be later after shedding load of the operator; and
when the sacrificial QoS criterion information of an operator having a margin in the calculated allowable level for QoS satisfaction is a delay time, setting an execution order of the operator to be later.

6. The method of claim 3, wherein the QoS satisfaction expectation information and/or the sacrificial QoS criterion information is set by the user.

7. A data processing device comprising:
a communication module to be connected to or communicate with a plurality of operators that constitute a plurality of services and are executed according to a data processing request of a user; and
a scheduler to calculate a maximum allowable delay time of each of the plurality of operators, to classify the plurality of operators based on the calculated maximum allowable delay time, to calculate an allowable level for QoS satisfaction with respect to each of the plurality of operators, to set execution orders of the plurality of classified operators by reflecting the calculated allowable level for QoS satisfaction, and to execute the plurality of operators based on the set execution orders,
wherein the allowable level for QoS satisfaction indicates the number of times that there is no need to satisfy one goal of QoS with the premise that there is no problem in satisfying QoS satisfaction requested by the user.

8. The device of claim 7, wherein an execution order of an operator having a margin in the calculated allowable level for QoS satisfaction is set to be later.

9. The device of claim 7, wherein when sacrificial QoS criterion information of an operator having a margin in the calculated allowable level for QoS satisfaction is accuracy, an execution order of the operator is set to be later after shedding load of the operator.

10. The device of claim 7, wherein when sacrificial QoS criterion information of an operator having a margin in the calculated allowable level for QoS satisfaction is a delay time, an execution order of the operator is set to be later.

11. The device of claim 7, wherein the scheduler is to verify sacrificial QoS criterion information of an operator having a margin in the calculated allowable level for QoS satisfaction, thereby when the sacrificial QoS criterion information of an operator having a margin in the calculated allowable level for QoS satisfaction is accuracy, setting an execution order of the operator to be later after shedding load of the operator, and when the sacrificial QoS criterion information of an operator having a margin in the calculated allowable level for QoS satisfaction is a delay time, setting an execution order of the operator to be later.

12. The device of claim 9, wherein the QoS satisfaction expectation information and/or the sacrificial QoS criterion information is set by the user.

13. A data processing method comprising:
requesting, by a user, data processing that is executed by a plurality of operators constituting a plurality of services; and
receiving an execution result according to a data processing request of the user,
wherein the data processing is performed by:
calculating a maximum allowable delay time of each of the plurality of operators;
classifying the plurality of operators based on the calculated maximum allowable delay time;
calculating an allowable level for QoS satisfaction with respect to each of the plurality of operators, wherein the allowable level for QoS satisfaction indicates the number of times that there is no need to satisfy one goal of QoS with the premise that there is no problem in satisfying QoS satisfaction requested by the user;
setting execution orders of the plurality of classified operators by reflecting the calculated allowable level for QoS satisfaction; and
executing the plurality of operators based on the set execution orders.

14. The method of claim 13, wherein an execution order of an operator having a margin in the calculated allowable level for QoS satisfaction is set to be later.

15. The method of claim 13, wherein when sacrificial QoS criterion information of an operator having a margin in the calculated allowable level for QoS satisfaction is accuracy, an execution order of the operator is set to be later after shedding load of the operator.

16. The method of claim 13, wherein when sacrificial QoS criterion information of an operator having a margin in the calculated allowable level for QoS satisfaction is a delay time, an execution order of the operator is set to be later.

17. The method of claim 13, wherein the setting of the execution orders of the plurality of classified operators by reflecting the calculated allowable level for QoS satisfaction comprises:
verifying sacrificial QoS criterion information of an operator having a margin in the calculated allowable level for QoS satisfaction;
when the sacrificial QoS criterion information of an operator having a margin in the calculated allowable level for QoS satisfaction is accuracy, setting an execution order of the operator to be later after shedding load of the operator; and
when the sacrificial QoS criterion information of an operator having a margin in the calculated allowable level for QoS satisfaction is a delay time, setting an execution order of the operator to be later.

18. The method of claim 15, wherein the QoS satisfaction expectation information and/or the sacrificial QoS criterion information is set by the user.
